(19) United States
(12) Patent Application Publication
(10) Pub. No.: US 2007/0152202 A1
(43) Pub. Date: Jul. 5, 2007

(54) Roller jack assembly and methods of using same

(76) Inventor: Wayne Kinney, Bethany, OK (US)

Correspondence Address: DUNLAP, CODDING & ROGERS P.C., PO BOX 16370, OKLAHOMA CITY, OK, 73113, US

(21) Appl. No.: 11/324,622

(22) Filed: Jan. 3, 2006

(51) Int. Cl. B66F 5/00

(52) U.S. Cl. 254/84

(57) ABSTRACT

A roller jack assembly is provided for supporting at least one roller of a dozer. The roller jack assembly includes a frame assembly, a jack frame assembly, and a jack assembly. The frame assembly is disposable on a supporting structure. The jack frame assembly is supported by the frame assembly. The jack frame assembly has a jack frame and means for selectively moving the jack frame along the frame assembly. The jack assembly is supported by the jack frame of the jack frame assembly. The jack assembly has a base frame, a jack supported by the base frame, means for selectively moving the base frame along the jack frame and a roller support member supported by the jack for engaging and supporting at least one roller of the dozer.

### CROSS REFERENCE TO RELATED APPLICATIONS

Not Applicable.

### BACKGROUND OF THE INVENTION

1. Field of the Invention

The present invention relates generally to devices for lifting equipment and more particularly, but not by way of limitation, to a device for removing and replacing rollers on dozers or any other such tracked vehicle.

2. Description of the Related Art

Lifting jacks capable of lifting, leveling or positioning heavy equipment are well known in the art. Whether a piece of equipment is lifted, lowered, or positioned to provide service to the piece of equipment, the piece of equipment must be supported by a structure that is both strong enough to support the weight of the piece of equipment and sufficiently stable that it will not displace and will prevent the piece of equipment from falling off the structure. Typically, a tractor, tank, half-trac, or other earth-moving vehicle, also referred to herein as a dozer, has a plurality of rollers. The rollers can be difficult to remove or repair due to the size and weight of each roller. Also, the plurality of rollers are positioned along the length of the dozer thus, a conventional jack must typically be manually adjusted, moved, and positioned beneath each roller. Conventional jacks are not constructed to provide the necessary stability to support the roller alone when removing or positioning a roller in relation to the dozer. Further, additional safety concerns arise each time the jack must be manually adjusted and moved.

To this end, a need exists for a device that will provide stable support and safer positioning of a jack beneath a roller. It is to such a roller jack assembly that the present invention is directed.

### BRIEF DESCRIPTION OF THE SEVERAL VIEWS OF THE DRAWINGS

FIG. 1 is a side elevational view of a roller jack assembly constructed in accordance with the present invention, the roller jack assembly having a dozer supported thereon.

FIG. 2 is a top view of the roller jack assembly of FIG. 1.

FIG. 3 is a perspective view of a jack assembly of the roller jack assembly of FIG. 2.

### DETAILED DESCRIPTION OF INVENTION

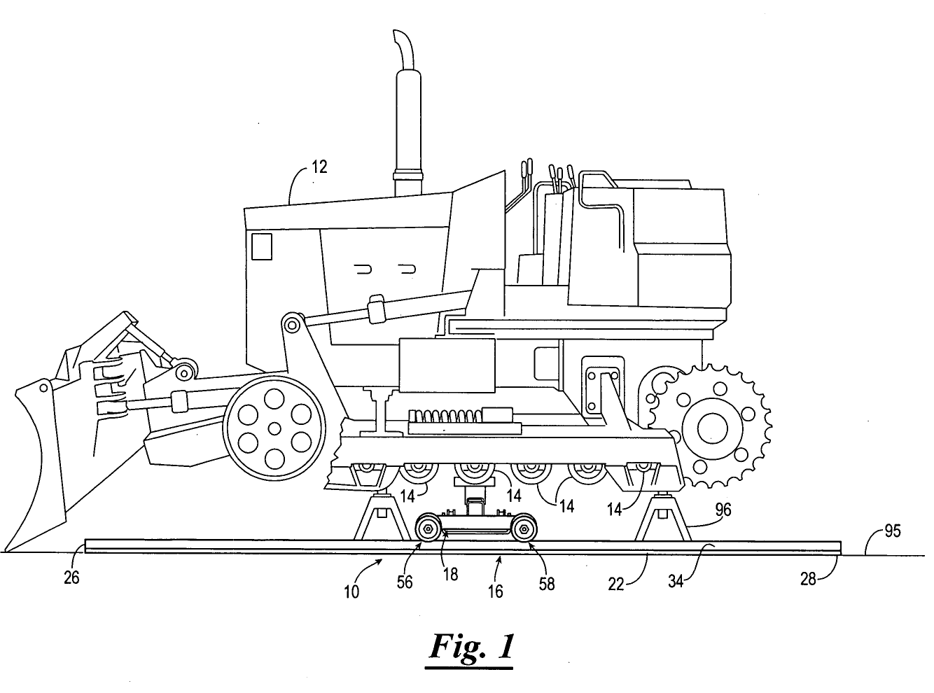

Referring now to the drawings, and more particularly to FIG. 1, a roller jack assembly 10 constructed in accordance with the present invention is shown having a dozer 12 positioned thereon. The dozer 12 is of conventional construction and includes a plurality of rollers 14 for supporting the dozer. The roller jack assembly 10 is constructed so that it can be used in conjunction with a variety of sizes of dozers. It should be understood that while a dozer is shown being used in conjunction with the roller jack assembly 10, the roller jack assembly 10 may be implemented for any such vehicle or device utilizing rollers. It should also be understood that while the jack assembly 10 is shown being used in conjunction with the dozer 12, the jack assembly 10 may also be modified to be used for lifting, leveling, or positioning other heavy equipment.

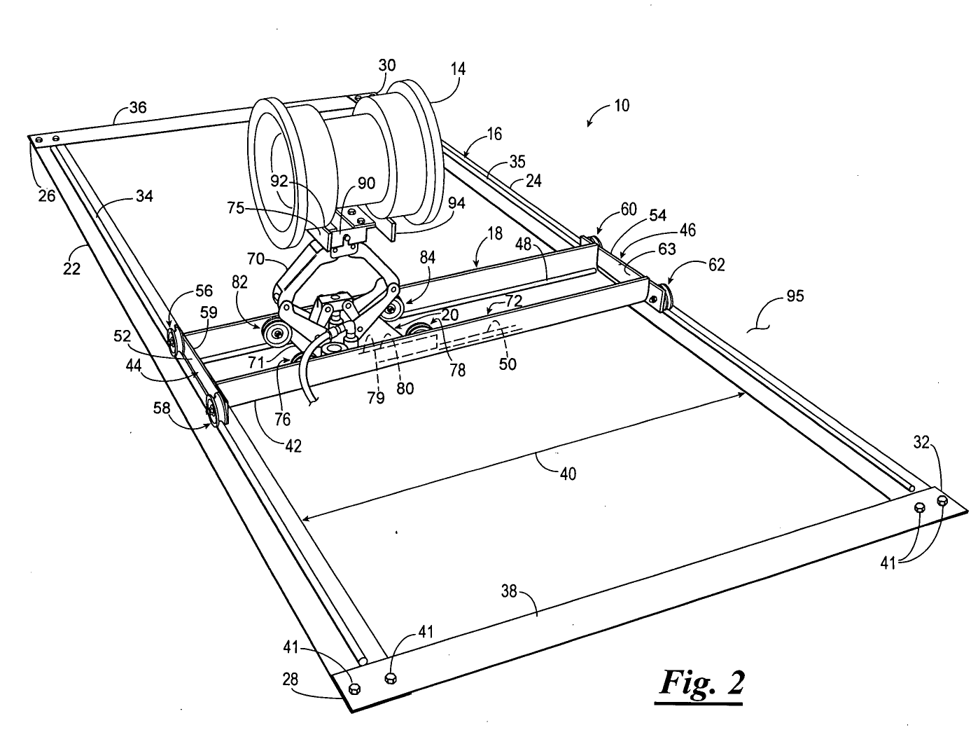

Referring now to FIGS. 1 and 2, the roller jack assembly 10 includes a base frame assembly 16, a jack frame assembly 18, and a jack assembly 20. The roller jack assembly 10 is used to support the dozer 12 so that one or more rollers 14 of the dozer 12 can be removed and/or replaced. The roller jack assembly 10 is preferably mobile so that the roller jack assembly 10 can be moved from one location to another. However, it should be understood that the dozer roller jack assembly 10 can be secured in a stationary position as well.

The base frame assembly 16 includes a first rail 22 and a spatially disposed second rail 24. The base frame assembly 16 is shown in FIG. 2 as having a substantially rectangular shape. However, it should be understood that the base frame assembly 16 may assume various shapes and configurations so long as the base frame assembly 16 functions in accordance with the present invention in a manner described herein.

The first rail 22 of the base frame assembly 16 has a first end 26 and a second end 28. The second rail 24 of the base frame assembly 16 has a first end 30 and a second end 32. The rails 22 and 24 are provided with elongated tracks 34 and 35, respectively. The track 34 extends along the rail 22 between the first end 26 and the second end 28. The track 35 extends along the second rail 24 between the first end 30 and the second end 32. It should be understood that the tracks 34 and 35 may be formed from metal stock or any other such material, and in various ways, in accordance with the present invention as long as the tracks 34 and 35 are capable of functioning in accordance with the present invention in the manner described herein.

The spatially disposed first rail 22 and second rail 24 of the base frame assembly 16 are connected by a first cross member 36 and a second cross member 38 so that the second rail 24 is substantially parallel to the first rail 22. Further, the first rail 22 is spaced a distance 40 from the second rail 24 so that the jack frame assembly 18 can be positioned therebetween. It should be understood that the distance 40 between the rails 22 and 24 will vary as the size of the rollers 14 or the size of the dozer 12 varies.

The first cross member 36 connects the first end 26 of the first rail and the first end 30 of the second rail 24. The second cross member 38 connects the second end 28 of the first rail 22 and the second end 22 of the second rail 24. The first and second cross members 36 and 38 are connected to the first and second rails 22 and 24 with pins 41 or any other such connector so as to be disassembled. However, it should be understood that the first and second cross members 36 and 38 may be connected to the first and second rails 22 and 24 by being welded together rather than bolted together. Although the base frame assembly 16 is preferably mobile, it should be understood that the base frame assembly 16 may be constructed in a fixed position. For example, grooves (not shown) may be formed in a concrete floor of a garage which are sized and dimensioned for receiving the first and second rails 22 and 24, respectively. Further, it should be understood that the base frame assembly 16 may be disposable on any supporting structure, such as asphalt, dirt, or the like.

The jack frame assembly 18 includes a frame 42, a first wheel assembly 44, and a second wheel assembly 46. The frame 42 of the jack frame assembly 18 includes a first rail 48 and a second rail 50. The frame 42 has a first side 52 and a second side 54. The first wheel assembly 44 of the jack frame assembly 18 includes a first wheel 56 and a second wheel 58 journally connected by a linkage member 59 so as to be spatially disposed a distance from one another. The linkage member 59 is operably connected to the first side 52 of the frame 42. The second wheel assembly 44 of the jack frame assembly 18 includes a third wheel 60 and a fourth wheel 62 journally connected by a linkage member 63 so as to be spatially disposed a distance from one another. The linkage member 63 is operably connected to the second side 54 of the frame 42. The first wheel assembly 44 and the second wheel assembly 46 of the jack frame assembly 18 cooperate to rollingly support the jack frame assembly 18. It should be understood that any number of wheel assemblies suitable to support the frame may be used. Further, preferably the wheels are concave shaped so as to prevent the build-up of dirt and dust. However, it should be understood that any various shaped wheel may be used, so long as the invention functions as is described herein. In addition, all the wheels are illustrated as the preferred structure for movably supporting the jack frame assembly 18, however, it should be understood that any other suitable structure for movably supporting or selectively moving the jack frame assembly 18 may be used, such as a roller.

The jack assembly 20 includes a jack 70, a base frame 71, a first wheel assembly 72, a second wheel assembly 74, and a roller support member 75. Preferably, the jack 70 is a conventional air over hydraulic jack. However, it should be understood that any such lifting jack may be used such as a screw or cylinder based actuator powered via hydraulic, mechanical, electric or manual means for lifting, leveling, or positioning heavy equipment. Because the operation of jacks is well-known in the art, as well as their various components, no further explanation of the construction and/or operation of the jack 70 will be given. The jack 70 is connected to the base frame 71 which provides support for the jack 70.

The first wheel assembly 72 of the jack assembly 20 includes a first wheel 76 journally connected to a second wheel 78 by a support member 79 so as to be spatially disposed a distance from one another. The support member 79 is operably connected to a first side 80 of the base frame 71. The second wheel assembly 74 includes a third wheel 82 journally connected to a fourth wheel 84 by a support member (not shown) so as to be spatially disposed a distance from one another. The support member is operably connected to a second side 86 of the base frame 71. The first wheel assembly 72 and the second wheel assembly 74 cooperate to rollingly support the jack 70. It should be understood that any number of wheel assemblies suitable to support the jack 70 may be used. Further, although a concave-shaped wheel is preferred so as to prevent build-up of dirt, any shaped wheel may be used so long as the invention functions as described herein. In addition, it should be understood that any other suitable structure for movably supporting or selectively moving the jack assembly 20 may be used.

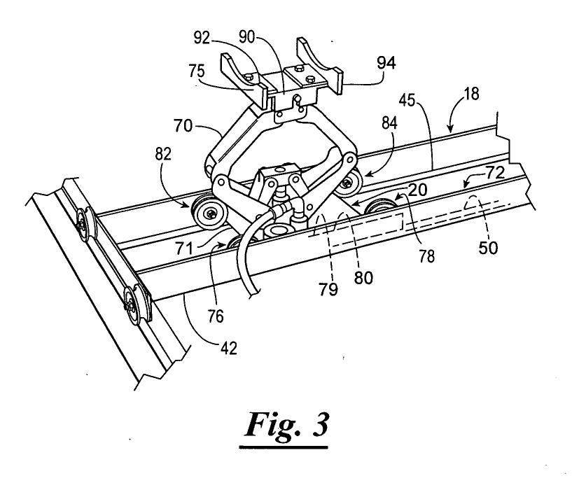

As shown in FIGS. 2 and 3, the roller support member 75 is connected to the jack 70 so as to engage and support the roller 14. The roller support member 75 is attached to the jack 70 with screws and bolts, however, it should be understood that the roller support member 75 may be secured to the jack 70 by a weld, an adhesive, or the like. The roller support member 75 includes a base 90 and a pair of concave support members 92 and 94 positioned on opposite sides of the base 90. The concave support members 92 and 94 are sized and dimensioned to receive the roller 14.

Referring to FIGS. 1-3, in use, the base frame assembly 16 is positioned on a supporting surface or structure 95, such as the ground, a concrete or asphalt pad, or the like. The dozer 12 may be positioned over the base frame assembly 16 of the roller jack assembly 10. A conventional jack is used to raise a portion of the dozer 12 in order to provide access to the underside of the dozer 12. Supports 96 may be provided and positioned beneath the dozer 12 to assist in holding up portions of the dozer 12. The jack frame assembly 18 is positioned between the first and second rails 22 and 24 of the base frame assembly 16. The jack assembly 20 is positioned on the first and second rails 48 and 50 of the jack frame assembly 18. The jack frame assembly 18 is rollingly moved along the length of dozer 12. The jack assembly 20 is rollingly moved in conjunction with the jack frame assembly 18 so that the roller support member 75 is disposed beneath the desired roller 14. The roller support member 75 is positioned so as to be aligned with the roller 14 so that when the jack 70 is actuated the roller support member 75 is raised to engage and receive the roller 14 or other piece of equipment. Once the roller support member 75 engages the roller 14, the jack 70 is actuated to lower the roller support member 75 which is mated with the roller 14. The roller 14 is removed from the dozer or positioned so as to be serviced. Once the roller 14 has been removed or has been serviced, a new roller 14 or the fixed roller 14 is raised to the dozer 12 by actuating the jack 70. The roller 14 is replaced on the dozer 12.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art in which are accomplished within the spirit of the invention disclosed.

What is claimed is:

1. A roller jack assembly for supporting at least one roller of a dozer, the roller jack assembly comprising:
a frame assembly disposable on a supporting structure;
a jack frame assembly supported by the frame assembly, the jack frame assembly having a jack frame and means for selectively moving the jack frame along the frame assembly; and
a jack assembly supported by the jack frame of the jack frame assembly, the jack assembly having a base frame, a jack supported by the base frame, means for selectively moving the base frame along the jack frame and a roller support member supported by the jack for engaging and supporting at least one roller of the dozer.

2. The roller jack assembly of claim 1 wherein the frame assembly is provided with a first rail and a spatially disposed second rail.

3. The roller jack assembly of claim 2 wherein the first and second rails are connected by at least one cross member for providing stability to the base frame assembly.

4. The roller jack assembly of claim 2 wherein the first and second rails are provided with elongated tracks.

5. The roller jack assembly of claim 1 wherein the means for selectively moving the jack frame is at least one wheel assembly having at least one wheel.

6. The roller jack assembly of claim 5 wherein the at least one wheel is concave.

7. The roller jack assembly of claim 1 wherein the means for selectively moving the base frame is at least one wheel assembly having at least one wheel.

8. The roller jack assembly of claim 7 wherein the at least one wheel is concave.

9. The roller jack assembly of claim 1 wherein the roller support member is provided with at least one concave support member for matingly engaging and supporting at least one roller of the dozer.

10. A roller jack assembly for supporting at least one roller of a dozer, the roller jack assembly comprising:
a frame assembly having a first rail and a spatially disposed second rail;
a jack frame assembly supported by the first and second rails, the jack frame assembly having a jack frame and means for selectively moving the jack frame along the frame assembly; and
a jack assembly supported by the jack frame of the jack frame assembly, the jack assembly having a base frame, a jack supported by the base frame, means for selectively moving the base frame along the jack frame and a roller support member supported by the jack for engaging and supporting at least one roller of the dozer.

11. The roller jack assembly of claim 10 wherein the first and second rails are connected by at least one cross member for providing stability to the base frame assembly.

12. The roller jack assembly of claim 10 wherein the first and second rails are provided with elongated tracks.

13. The roller jack assembly of claim 10 wherein the means for selectively moving the jack frame is at least one wheel assembly having at least one wheel.

14. The roller jack assembly of claim 13 wherein the at least one wheel is concave.

15. The roller jack assembly of claim 10 wherein the means for selectively moving the base frame is at least one wheel assembly having at least one wheel.

16. The roller jack assembly of claim 15 wherein the at least one wheel is concave.

17. The roller jack assembly of claim 10 wherein the roller support member is provided with at least one concave support member for matingly engaging and supporting at least one roller of the dozer.

18. A method for supporting a roller from a dozer, the method comprising the steps of:
disposing a frame assembly on a supporting structure;
disposing a jack frame assembly on the frame assembly;
disposing a jack assembly on the jack frame assembly;
positioning a dozer over the frame assembly;
moving the jack frame assembly under at least one roller of the dozer;
moving the jack assembly in conjunction with the jack frame assembly so that a roller support member is positioned beneath at least one roller of the dozer;
moving the jack to a position wherein the roller support member is raised to matingly engage and receive at least one roller of the dozer; and
moving the jack to a position wherein the roller support member which is mated with the roller is lowered away from the dozer.

19. The method of claim 18 further comprising the step of:
moving the jack so as to raise the roller support member which is mated with the roller to the dozer.

20. The method of claim 18 wherein the jack frame assembly is disposed upon a first rail and a spatially disposed second rail of the frame assembly.
